(19) United States
(12) Patent Application Publication
(10) Pub. No.: US 2009/0113499 A1
(43) Pub. Date: Apr. 30, 2009

(54) METHOD AND APPARATUS FOR CONTROLLING AN ON-PREMISES DIGITAL MEDIA DISTRIBUTION SYSTEM

(76) Inventor: Mark Clifford Evensen, Tung Chung (HK)

Correspondence Address: COOLEY GODWARD KRONISH LLP;ATTN: Patent Group, Suite 1100, 777 - 6th Street, NW, WASHINGTON, DC, 20001, US

(21) Appl. No.: 11/928,272

(22) Filed: Oct. 30, 2007

(51) Int. Cl. H04N 7/173

(52) U.S. Cl. 725/109

(57) ABSTRACT

A method and apparatus for controlling an on-premises digital media distribution system is described. One embodiment places a device in a registration mode responsive to user input, the device being configured to decode and modulate received digital media content for distribution in analog format within a premises; receives in a wireless remote control unit a registration input from the user; transmits, responsive to the registration input, a registration message from the wireless remote control unit to the device, the registration message including a unique identifier associated with the wireless remote control unit; binds the wireless remote control unit to a media processing unit within the device such that the media processing unit responds to only those command messages subsequently received from the wireless remote control unit containing the unique identifier associated with the wireless remote control unit; and terminates the registration mode and resumes an operating mode in the device.

### RELATED APPLICATIONS

The present application is related to commonly owned and assigned U.S. application Ser. No. 11/764,035, Attorney Docket No. ENTO-003/00US, entitled “Method and System for Controlling Access to Media Content Distributed Within a Premises,” filed on Jun. 15, 2007.

### COPYRIGHT

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to devices and associated methods for interfacing typical consumer electronics devices and computers to sources of digital media content for the purpose of providing information, entertainment, and other value-added communications services. In particular, but not by way of limitation, the present invention relates to methods and apparatuses for controlling an on-premises digital media distribution system.

### BACKGROUND OF THE INVENTION

Advances in semiconductor and optical transmission and switching technologies have enabled the cost-effective delivery of digital entertainment and information services via broadband IP networks. These broadband IP networks are often implemented using underlying network technologies such as Digital Subscriber Line (DSL) or Fiber To The Premises (FTTP) and can also be implemented using coaxial cable or wireless facilities. In most cases existing consumer electronics equipment (e.g., television sets) and computers are not directly compatible with the broadband IP network's data formats and protocols.

One solution is to convert compressed digital content received at a premises to a standard analog signal format such as that of the National Television Standards Committee (NTSC) using suitable on-premises equipment. To distribute the analog signal to standard analog televisions throughout the premises, the analog video is modulated onto a particular carrier frequency and amplified, and the modulated, amplified signal is fed to the analog televisions via a coaxial network or via wireless transmission within the premises. By tuning to the appropriate carrier frequency, a viewer can view the analog signal from the on-premises equipment on any analog television in the household. In some versions of this solution, the on-premises equipment includes multiple decoders to produce multiple output video streams, the output of each decoder being modulated onto a unique carrier frequency. The viewer changes channels within a given stream by inputting an appropriate command to the on-premises equipment.

One common way in which a user can input commands to the on-premises equipment is through the use of a wireless remote control. Such remote controls are commonly used to control devices such as a televisions, VCRs or stereos. It is also common to have many different types of collocated devices so that when a command is transmitted from a remote control intended for a specific device, that command can end up being received by several devices. To allow for such circumstances, manufacturers typically try to make their protocols different from those other manufacturers. Further, a given manufacturer usually employs distinct protocols for different categories of its own products. For example, a manufacturer might have one protocol for controlling VCRs and a different protocol for controlling TVs.

In conventional devices, then, there is an assumption that if a device receives a command it recognizes, the device should respond to that command. This implicit relationship between a remote control and a device based solely on having a compatible protocol is not suitable for all applications. For example, if the device includes multiple resources (e.g., multiple decoders) that can be accessed simultaneously by multiple users, it is valuable to know precisely which remote control sent a particular command.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

The present invention can provide a method and apparatus for controlling an on-premises digital media distribution system. One illustrative embodiment is a method for controlling a device, the method comprising placing the device in a registration mode in response to an input to the device from a user, the device being configured to decode and modulate received digital media content for distribution in analog format within a premises; receiving in a wireless remote control unit that is separate from the device a registration input from the user; transmitting, responsive to the registration input, a registration message from the wireless remote control unit to the device while the device is in the registration mode, the registration message including a unique identifier associated with the wireless remote control unit; binding the wireless remote control unit to a media processing unit within the device in response to the registration message such that the media processing unit responds to only those command messages subsequently received from the wireless remote control unit that contain the unique identifier associated with the wireless remote control unit; and terminating the registration mode and resuming an operating mode in the device.

Another illustrative embodiment of the invention is a system, comprising a customer premises unit to decode and modulate received digital media content for distribution in analog format within a premises, the customer premises unit including a media processing unit; and a wireless remote control unit to control the operation of the customer premises unit; wherein: the customer premises unit is configured to enter a registration mode in response to an input to the customer premises unit from a user; the wireless remote control unit is configured to receive a registration input from the user and, responsive thereto, to transmit a registration message to the customer premises unit while the customer premises unit is in the registration mode, the registration message including a unique identifier associated with the wireless remote control unit; the customer premises unit is configured to bind, in response to the registration message, the wireless remote control unit to the media processing unit such that the media processing unit responds to only those command messages subsequently received from the wireless remote control unit that contain the unique identifier associated with the wireless remote control unit; and the customer premises unit is configured to terminate the registration mode and resume an operating mode once the wireless remote control unit has been bound to the media processing unit.

These and other embodiments are described in further detail herein.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings, wherein:

FIG. 1 is a block diagram of one embodiment of the present invention;

FIG. 2 is a block diagram of a customer premises unit (CPE) constructed according to one embodiment of the present invention;

FIG. 3 is a block diagram of an exemplary media processing unit;

FIG. 4 is a block diagram of a customer premises unit (CPE) constructed according to another embodiment of the present invention;

FIG. 5 is an illustration of the inputs and outputs of one embodiment of the present invention;

FIG. 6A is a block diagram of a customer premises unit (CPE) constructed according to yet another embodiment of the present invention;

FIG. 6B is a functional diagram of a memory of the customer premises unit (CPE) shown in FIG. 6A according to an illustrative embodiment of the present invention;

FIG. 7 is a flowchart of a method for controlling access to media content within a premises in accordance with an illustrative embodiment of the present invention;

FIG. 8 is a functional block diagram of an on-premises digital media distribution system in accordance with an illustrative embodiment of the invention;

FIG. 9 is a flow diagram of a method for controlling a CPE in accordance with an illustrative embodiment of the invention;

FIG. 10 is a flow diagram of a method for controlling a CPE in accordance with another illustrative embodiment of the invention;

FIG. 11 is a flow diagram of a method for controlling a CPE in accordance with yet another illustrative embodiment of the invention; and

FIG. 12 is a diagram of a wireless remote control message format in accordance with an illustrative embodiment of the invention.

### DETAILED DESCRIPTION

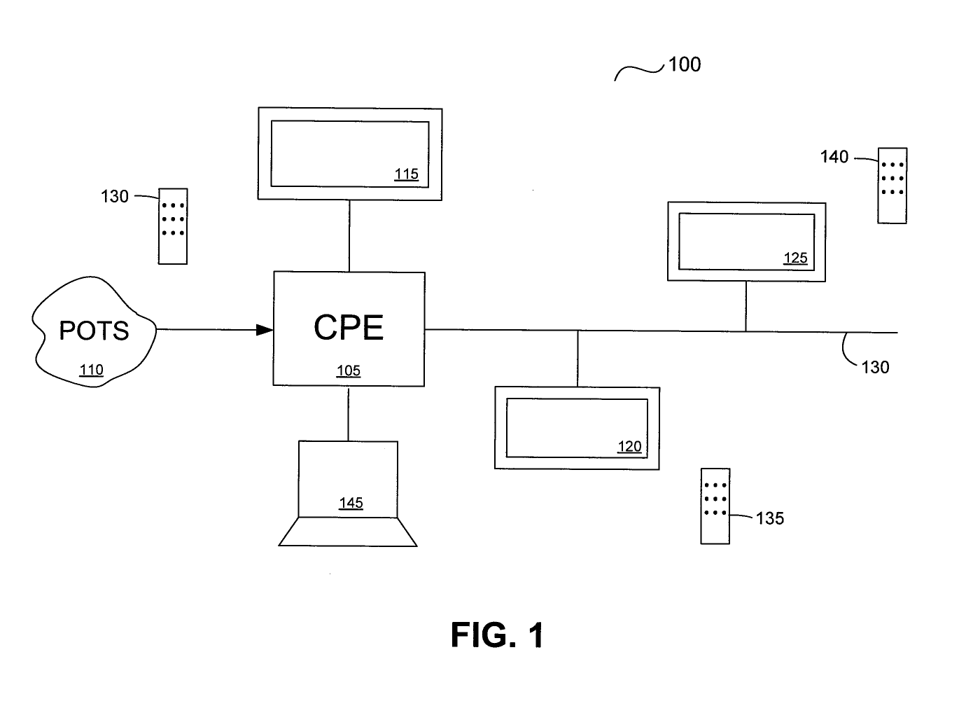

Referring now to the drawings, where like or similar elements are designated with identical reference numerals throughout the several views, and referring in particular to FIG. 1, it illustrates a block diagram of one embodiment of the present invention 100. This embodiment includes a customer premises equipment (CPE) 105 that receives data from and transmits data to a broadband IP network 110. For example, the CPE 105 could receive digital television programming over the twisted-pair telephone line common to most homes. The CPE 105 could also receive digital television programming over a fiber network, provided that the format of the data was IP based.

Regardless of the method by which it receives data, the CPE 105 can select incoming data based on use commands, decode incoming data and deliver the decoded information to one of the multiple televisions 115, 120, 125 connected to the CPE 105. This embodiment of the CPE 105 is configured to simultaneously decode three channels of programming and deliver the decoded data to three or more separate televisions 115, 120, 125. Stated differently, this CPE 105 can independently and simultaneously drive three different televisions, thereby allowing up to three different programs to be viewed or heard on each television. Note that the televisions can be replaced with any type of entertainment system, including stereos and game units.

The first television 115, in this embodiment, is directly coupled to the CPE 105 and can receive high fidelity video signals through variety of common interfaces. Additionally, the CPE 105 can directly output digital audio signal through, for example, an optical out connector. Other ways for connecting a set-top box and a television/audio system are well known to those skilled in the art and are not discussed further.

Still referring to FIG. 1, the second and third televisions 120, 125 are generally indirectly connected to the CPE 105, which means that the data is often modulated onto a VHF or UHF frequency and delivered to the televisions (henceforth the term VHF will refer those VHF and UHF frequencies that are typically used for the transmission of modulated analog television standards, such as NTSC, PAL, SECAM and the many variants of these standards in use worldwide). The second and third televisions are often remotely located from the CPE 105, and a direct connection, e.g., an unmodulated signal, would often require running new wire through a house or business. Because most consumers are hesitant to rewire their home or business, the CPE is configured to use existing in-home coaxial wiring 130 to deliver television and audio programming. (“In-home” refers to any system or device located at a customer location, whether the customer is located at a home, business or other location.) This in-home wiring 130 specifically includes a typical coaxial cable network that is common to homes that are prewired for cable television.

To independently drive multiple televisions using a digital signal, traditional systems require a set-top box at each television to decode the digital signals. But consumers are also hesitant to purchase or lease multiple set-top boxes. Accordingly, this embodiment of the CPE 105 prevents consumers from needing set-top boxes. For example, the CPE 105 can modulate a decoded digital video signal onto a VHF channel and transmit the modulated signal over the in-home wiring 130. Any television connected to the in-home wiring 130 could view the signal by tuning to the appropriate VHF channel. And no set-top box is required at that television.

By using multiple decoders in the CPE 105, different streams of data can be modulated at different VHF frequencies. For example, one stream of programming could be modulated onto channel 3 and another stream modulated onto channel 7. Thus, a television tuned to VHF channel 3 could view the first stream and a television tuned to channel 7 could view the second stream.

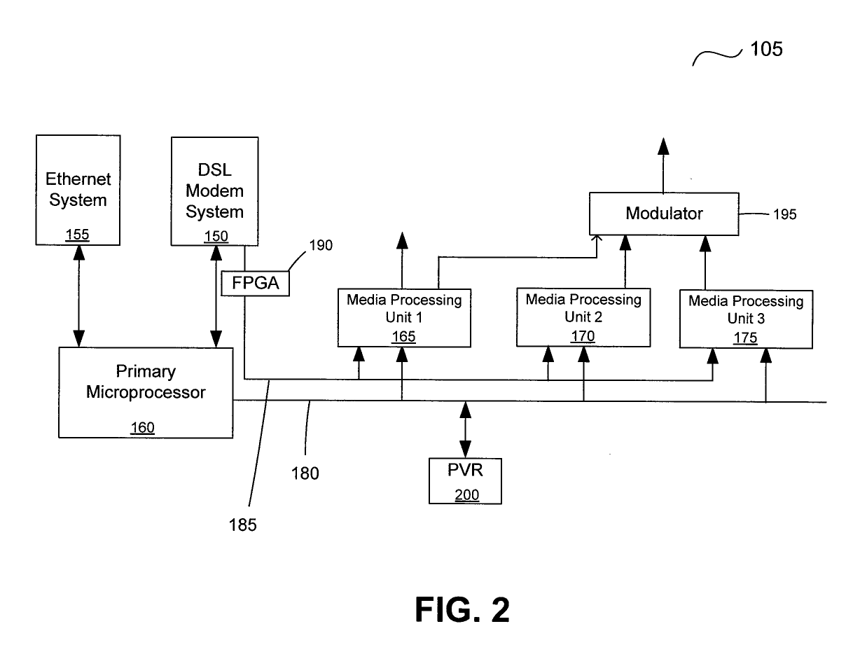

Each of the first, second, and third televisions 115, 120, 125 are independently controllable either at the CPE 105 or by corresponding remote controls 130, 135, 140. These remote controls are typically RF based and can control the CPE 105 from locations within the residence without direct line of sight access to the CPE 105. For example, the third remote control 140 corresponds to the third television 125. This remote control 140 can control functions at the CPE 105 such as changing the channel that is being decoded and sent to the third television 125. This process is described further with reference to FIG. 2.

As shown in FIG. 1, the CPE 105 can be connected to a home computer 145 or an in-home network 130 such as an Ethernet or wireless system. The CPE 105 acts to direct data that it receives from, for example, a Web site, a data network, a programming provider, etc., to the home computer 145, and also receives data from the home computer 145 and transmits it to the broadband IP network. The CPE 105 also acts to direct data between the home computer 145 and the CPE 105. For example, the CPE 105 could receive home videos from the computer 145 and provide those home videos to one of the three televisions 115, 120, 125. Similarly, a video stream received at the CPE 105 could be routed to and stored at the home computer 145.

Referring now to FIG. 2, it is a block diagram of one embodiment of the CPE 105. This embodiment includes an DSL modem 150 and an Ethernet system 155 that relay input data to the primary microprocessor 160. The DSL modem 150 can provide access to Internet service providers, video-on-demand providers, audio providers, and television programming providers. Video and audio service can be received at the CPE 105 in many formats, although the currently preferred format is MPEG-2 encapsulated in IP.

The Ethernet system 155 is configured to provide a connection to an Ethernet network. One embodiment of the Ethernet system 155 supports 10Base-T, 10 Base-T full duplex, 100Base-T, and/or 100Base-T full duplex. Of course, the Ethernet system 155 can be configured to support many transport modes. And on a broad scale, the Ethernet system 155 can be replaced with other types of network connection systems.

The DSL modem 150, in this embodiment, is configured to extract IP packets from incoming data and place the extracted packets on the data bus 180, which in this embodiment is a PCI bus. The IP packets can alternatively be sent to the media processing units 165, 170, 175 via the MPEG bus 185 and the field programmable gate array 190. The MPEG bus is generally connected directly to the decoder portion of the media processing units 165, 170, 175. Accordingly, packets arriving over the MPEG bus 185 avoid some of the processing that is required for packets that arrive over the data bus 180.

Generally, the DSL modem 150 or the FPGA 190 decide which packets to route via the MPEG bus 185 or the data bus 180. Note that the DSL modem and the FPGA can be integrated into a single unit. Also note that the FPGA can be replaced with any type of logic unit.

Factors in deciding which bus to use in the transfer include: type of data, whether the data is encrypted, whether the data requires further processing prior to decoding; whether the data can be directly decoded. For example, the DSL modem 150 could determine that the incoming packets are encrypted and route those packets to the media processing unit 2 (170) via the data bus 180. Other incoming packets may be ready for direct decoding and routed to the same media processing unit via the MPEG bus 185.

Typically, the DSL modem 150 extracts the IP packets associated with a particular channel of video data that is requested by one of the media processing units 165, 170, 175. The extracted packets can be addressed to a particular media processing unit 165, 170, 175 based on the requests by that particular media processing unit.

The media processing units 165, 170, 175 accept the appropriate data from the data bus 180, decode and decrypt that data (if necessary), and provide the data in viewable form to the television corresponding to the media processing unit. This data can be provided to the appropriate television in a variety of ways. For example, the first media processing unit includes direct outputs for driving the television. The direct output can include any of the outputs typical to the video industry. The direct output can also include direct audio outputs, including digital audio outputs.

The media processing units, in this embodiment, can be configured to provide decoded data to remotely located televisions in an analog format. For example, the media processing units can output a decoded video signal to a modulator 195. The modulator 195 can then convert the decoded signal into a VHF signal that can be transmitted to the remotely located televisions. For example, the modulator 195 can convert the data output from the second media processing unit to VHF channel 3. Thus, any television that is connected to the modulator 195 and that is tuned to channel 3 can view the decoded signal from the second media processing unit. Similarly, any television that is connected to the modulator 195 and that is tuned, for example, to channel 7 can display the decoded signal from the third media processing unit.

The modulator 195 can be connected to the remotely located televisions by an internal network 130. Typically, this internal network is based on in-home coaxial cable wiring. Many houses are wired with a coaxial cable, and the modulator 195 takes advantage of this fact by transmitting the video signal over the existing cable. Thus, the consumer does not need to install new wiring from the CPE to the remotely located televisions. In certain embodiments, however, new network wiring can be installed or a wireless network can be used.

In certain embodiments of the present invention, a digital media recorder (DMR) 200 can be attached to the data bus 180. The DMR 200 can record programming output by the communications processing unit 160 and subsequently transmit that programming to a particular one of the media processing units for viewing. For example, the DMR 200 could transmit the program data encapsulated over the data bus 180 to a particular one of the media processing units 165, 170, 175.

The DMR functions can be controlled by any of the media processing units 165, 170, 175. Thus, a particular media processing unit could request that the DMR 200 retrieve certain program data and send it to that media processing unit. Certain DMR functions for certain media processing units, however, may be restricted based on set-up configurations or parental controls.

Still referring to FIG. 2, the DMR 200 in this embodiment could be partitioned into logical storage units so that each media processing unit is associated with only one portion of the DMR 200. Users would essentially experience three separate DMRs—one for each media processing unit. Alternatively, the DMR 200 could operate as a single DMR 200 with a common storage area. And in this embodiment, users would experience a shared DMR for all three media processing units.

In yet another embodiment, the DMR 200 could include a common storage area and separate private storage areas. In this embodiment, users would experience an independent DMR 200 for each media processing unit, but also have the ability to share programming with the other media processing units or other logical DMR units. In all of these embodiments, the DMR 200 could be controlled from the user interface associated with the particular media processing units. This user interface is discussed below.

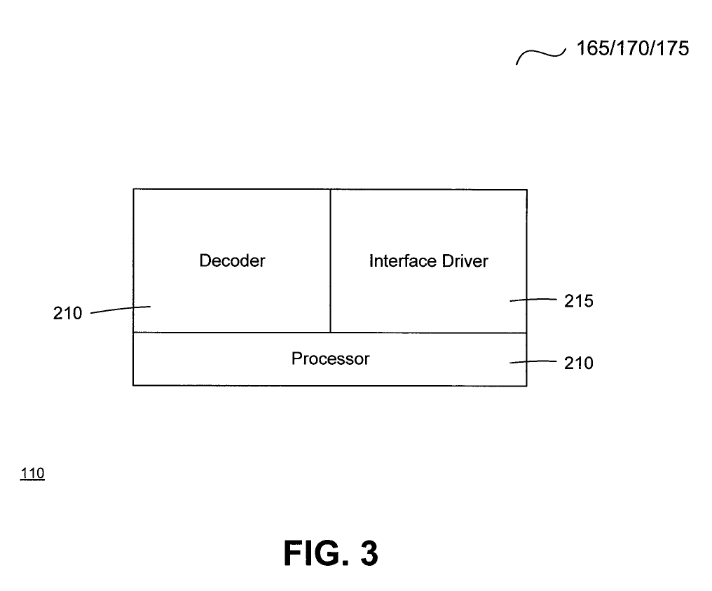

Referring now to FIG. 3, it is a block diagram of one exemplary media processing unit 165, 170, or 175. This embodiment includes a processor 205, a decoder 210, and an interface driver 215. The processor 205 can be any type of microprocessor or microcontroller. It can operate directly as a decoder, or it can control an integrated or free-standing decoder. The processor 205 can also decrypt video packets if necessary and request routing of video packets from the communications processing unit to the corresponding media processing unit. The processor 205 can also operate software for the interface driver.

The interface driver 215 can generate an interactive program guide, including a video-on-demand guide, a program guide, and/or setup controls. The data for the interactive program guide could be stored local to the media processing unit 165, 170, 175 or stored elsewhere in the CPE 105. And in certain cases, the data for the interactive program guide may be stored outside the CPE 105 such that the interface driver 215 would need to request the data from an outside source.

The interface driver 215 could enable the creation of parental controls and customized user setups. The settings for a customized program guide and/or the parental controls can be stored in a memory local to the media processing unit or in another memory location within the CPE 105.

Notably, each media processing unit 165, 170, 175 can incorporate its own interface driver 215. Thus, the user experiences a different interactive program guide for each media processing unit and associated television. In other embodiments, the interface driver 215 is centralized and individual threads are spun for each media processing unit, thereby allowing each media processing unit 165, 170, 175 to appear to have a unique interface driver. In either embodiment, however, the interface driver 215 for a particular media processing unit can be controlled through the remote control corresponding to the media processing unit. For example, the interface driver 215 in the first media processing unit 165 can be controlled by the remote control 130 corresponding to that media processing unit 165.

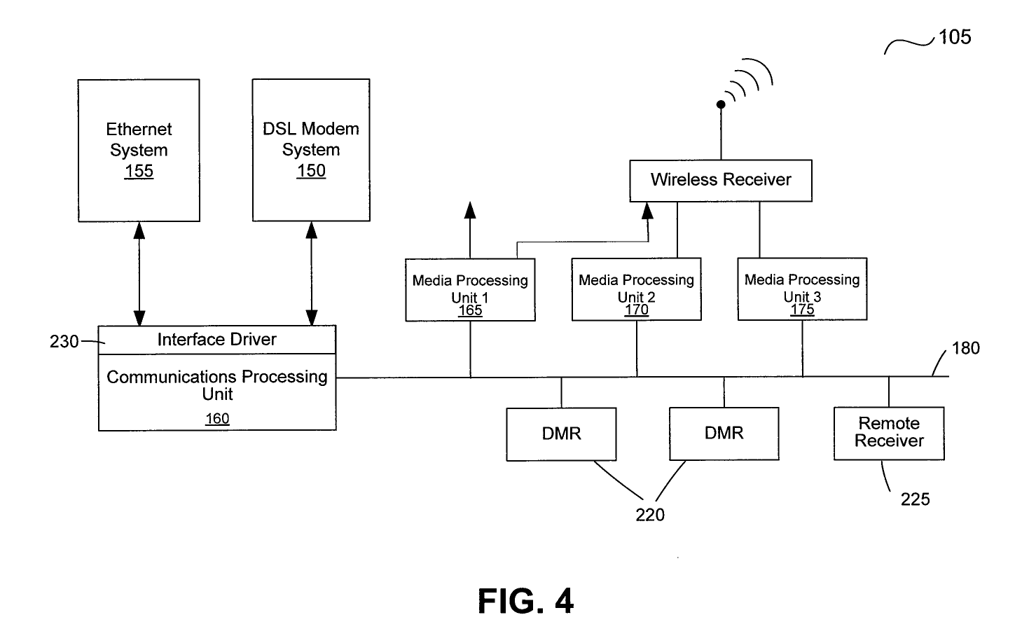

Referring now to FIG. 4, it is a block diagram of another embodiment of the CPE 105. This embodiment includes several of the same components as the version shown in FIG. 2. The common components are not necessarily discussed further.

This version of the CPE 105 includes a distributed DMR 220. That is, the storage for video and audio programming can be distributed among multiple devices. The DMR functionality or DMR data storage duties can even be assigned to a home computer 145 attached to the CPE 105. Data can be routed and stored within the distributed storage according to any of the well-known methods.

This version of the CPE 105 also includes a remote control receiver 225 for receiving instructions from the remote controls. This receiver is attached directly to the data bus 180, which can be a PCI bus. The receiver can also be distributed among the individual media processing units 165, 170, 175.

The interface driver 230 in this embodiment is remotely located from the media processing units 165, 170, 175. Notably, the interface driver 230 is capable of simultaneously providing a unique user interface for each of the media processing units 165, 170, 175. In essence, the interface driver 230 can operate separate interface threads for each media processing unit, thereby providing each media processing unit with a potentially unique user interface. And whether distributed or centralized, the interface driver can also include a master interface where overall system settings can be established. For example, parental controls can be applied to all media processing units through this master interface. Settings for the master interface could be stored local to the media processing units, local to the centralized interface driver, or somewhere else in the CPE 105.

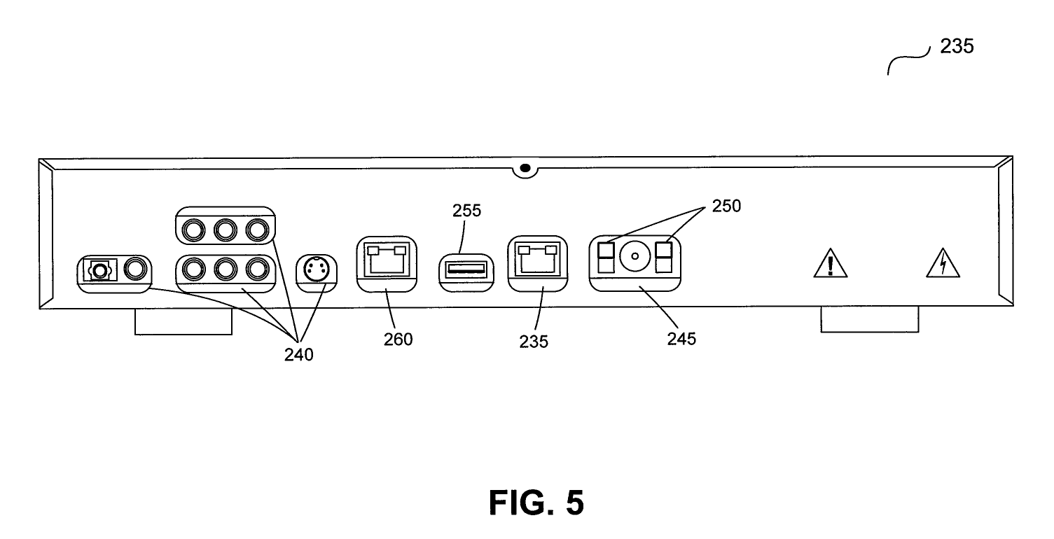

Referring now to FIG. 5, it is an illustration 235 of the connectors used by an exemplary CPE 105. These connectors are defined by standards that are widely available. Accordingly, the specifics of the connectors are not described herein. Briefly, however, this version of the CPE includes a power supply input (not shown), a DSL interface (including caller identification capability) 235, direct television output interfaces including an S-video output 240, a remote television output interface with a channel selector 245, 250, an RF receiver supporting multiple remote controllers (not shown), a USB port 255, and a 10/100BT Ethernet LAN port 260. Other embodiments may include new connectors or may eliminate any of these connectors.

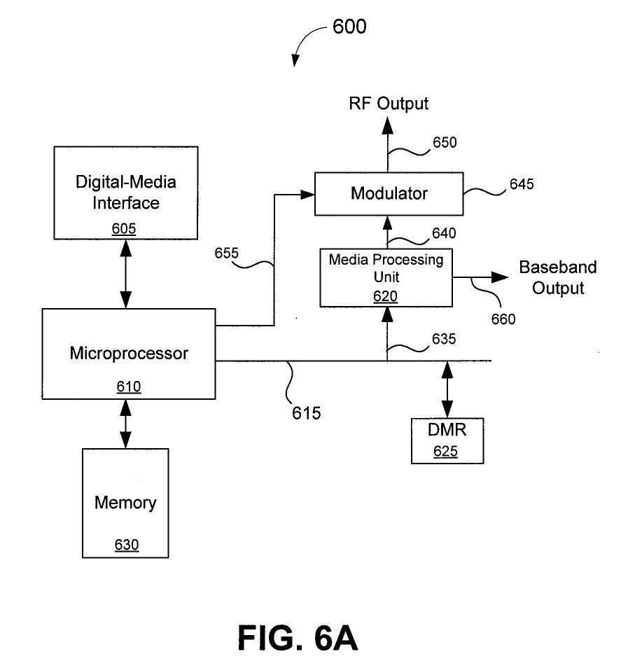

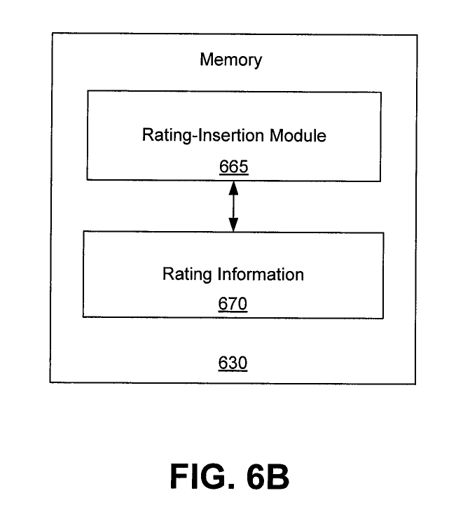

Referring now to FIG. 6A, it is a block diagram of a customer premises unit (CPE) 600 constructed according to yet another embodiment of the present invention. This illustrative embodiment includes parental-control capabilities. CPE 600 is configured to receive digital content at a premises from any of a variety of sources and to receive, at the premises, rating information for the various programs in the digital content. In this context, “premises” refers to a residence, commercial building, or group of buildings, whether residential or commercial, on a particular tract of land. CPE 600 decodes the digital content to produce decoded content, embeds rating indicators with the respective programs in the decoded content based on the rating information, and modulates the rated-decoded content including the rating indicators to produce rated-modulated content that includes the embedded rating indicators.

The rated-modulated content is transmitted to one or more analog televisions on the premises that are capable of selectively blocking programs based on the embedded rating indicators. In short, CPE 600 restores rating information that would otherwise be lost when content is converted from digital format to analog format for distribution to analog televisions within a premises. This enables a parent or other authorized user to exercise control over what classes of content may be viewed on a particular analog television by simply configuring the analog television to block particular classes of content.

In one embodiment, the embedded rating indicators are encoded in the vertical blanking interval of an NTSC signal and are compatible with well-known V-chip technology. As those skilled in the art are aware, V-chip technology is similar to that used for providing closed-captioning and emergency-alert services. In V-chip technology, the rating data is encoded within the vertical blanking interval of the NTSC signal using frequency-shift-keying (FSK) modulation. Further details regarding V-chip technology are described in U.S. Pat. Nos. 4,554,584 and 5,828,402, both of which are herein incorporated by reference.

A parent or other authorized user can configure an analog television equipped with a V-chip to block particular categories of content. For example, a parent might decide to configure the V-chip in a child's television to block all programming bearing a Federal Communications Commission (FCC) rating of “TV-14” (“Parents Strongly Cautioned”) or “TV-MA” (“Mature Audiences Only”). In other embodiments, the rating indicators are restored to the analog video signal in accordance with a predetermined format other than the V-chip standard.

In FIG. 6A, digital-media interface 605 receives digital content at the premises where CPE 600 is located. The received digital content may include, for example, movies, episodic television programs, documentaries, and news, and the digital content may be received from any of a variety of sources, including, without limitation, digital cable, digital satellite, digital subscriber loop (DSL), optical fiber, and one or more on-premises digital-media recorders (DMRs). In some embodiments, digital-media interface 605 is configured to receive digital content from multiple sources.

Depending on the particular embodiment, digital-media interface 605 may include a DSL modem, an Ethernet interface, or other suitable communication interface for receiving digital content. In some embodiments, digital-media interface 605 receives the digital content via an Internet-Protocol (IP) connection. In other embodiments, the digital content may be received via protocols other than IP.

The received digital content may be in any of a variety of formats, including, without limitation, MPEG-2, MPEG-4, Windows Media Video (WMV), or a combination of formats, depending on the particular content.

In FIG. 6A, microprocessor 610 communications over data bus 615 with media processing unit 620 and optional DMR 625 (e.g., a digital video recorder). DMR 625 is shown primarily for illustration purposes and is not necessarily present in all embodiments. In some embodiments, a user can optionally connect DRM 625 with data bus 615. Microprocessor 610 is also connected with memory 630. Digital content 635 is fed to media processing unit 620, which outputs decoded content 640. In one embodiment, decoded content 640 includes separate baseband analog video and audio signals. Modulator 645 modulates decoded content 640 onto a predetermined carrier frequency to produce analog radio-frequency (RF) rated-modulated content (e.g., an NTSC signal) at RF output 650.

Modulator 645, under the control of microprocessor 610 via control line 655, embeds a rating indicator with a given program in the decoded content. That is, microprocessor 610 determines (e.g., based on a stored programming schedule) that a particular program is being transmitted from RF output 650 and instructs modulator 645 via control line 655 to embed a rating indicator corresponding to rating information associated with that particular program. For example, the particular program might have an FCC rating of “TV-PG” (“Parental Guidance Suggested”). Modulator 645 embeds into decoded content 640 a rating indicator in the form of, e.g., ASCII text or a predetermined bit pattern that uniquely corresponds to the “TV-PG” rating to produce rated-decoded content including the particular program. Modulator 645 modulates the rated-decoded content onto a particular carrier frequency to produce, at RF output 650, rated-modulated content. The rated-modulated content is suitable for transmission to one or more analog televisions on the premises that are capable of selectively blocking the particular program based on the rating indicator embedded with the particular program.

As mentioned above, in some embodiments the rating indicators are compatible with V-chip technology. In the example just discussed, an analog television whose V-chip has been configured to block “TV-PG” programs would automatically block the particular program based on the embedded V-chip-compatible rating indicator.

As in the foregoing embodiments, to receive the analog signal (rated-modulated content), a viewer tunes the analog television to the appropriate VHF or UHF carrier frequency matching that of the rated-modulated content. A viewer can select a specific channel within the video stream by inputting a command to CPE 600 via controls (not shown in FIG. 6A) on CPE 600 itself or via an RF remote control, as described above. In some embodiments, the rated-modulated content is transmitted to the analog televisions via an existing coaxial network within the premises. In other embodiments, wireless distribution within the premises is used instead of or in addition to coaxial distribution.

In some embodiments, media processing unit 620 also includes baseband output 660 for outputting baseband video and audio signals in formats such as RCA, separate video (S-Video), or High-Definition Multimedia Interface (HDMI).

FIG. 6B is a functional diagram of the memory 630 of CPE 600 shown in FIG. 6A according to an illustrative embodiment of the present invention. Memory 630 can be any kind of memory, including, without limitation, random-access memory (RAM), read-only memory (ROM), flash memory, magnetic memory (e.g., a hard disk drive), optical memory, or a combination thereof. In the illustrative embodiment of FIG. 6B, memory 630 includes rating-insertion module 665, a program that manages the receipt, storage, and application of rating information 670. In one embodiment, rating-insertion module 665 is software or firmware that is executed by microprocessor 610. In general, the functionality of rating-insertion module 665 can be implemented in software, firmware, hardware, or any combination or sub-combination thereof. In this embodiment, rating-insertion module 665 communicates with modulator 645 via control line 655 to embed the appropriate rating indicator with each program in the decoded content 640 for which rating information 670 is available.

Rating information 670 may be received in advance of the associated programming in some embodiments. For example, some digital content providers transmit an electronic programming guide (EPG) up to two weeks before the applicable programs are broadcast. In one embodiment, CPE 600 is configured to store such advance rating information 670 for later use in inserting the rating indicators. By consulting the EPG or similar data, microprocessor 610 can determine what program is being transmitted from RF output 650 (the rated-modulated content) at any given time and can look up the corresponding stored rating information 670 to determine the corresponding rating indicator to be embedded in the out-going analog signal.

In another embodiment, rating information is obtained from a user interface associated with a vendor or content provider offering video-on-demand (VOD) programming. Such a user interface, often implemented on a Web site using Hypertext Markup Language (HTML) or Extensible Markup Language (XML), allows a viewer to select particular digital content on-line for immediate viewing or downloading. Such a user interface typically includes metadata that can be read by rating-insertion module 665 in response to the user's selection of a particular VOD program. This metadata typically includes rating information for the selected program.

In some situations, the rating information that CPE 600 receives for a particular program may be in accordance with a different rating system than that upon which the rating indicators are based. For example, a particular program might be a movie with a Motion Picture Association of America (MPAA) rating of “R,” for which there is no direct counterpart in the FCC rating system for television programs. In some embodiments, CPE 600 is configured to convert received rating information from one rating system to another. For example, in an embodiment in which CPE 600 is configured to output V-chip-compatible rated-modulated content, an MPAA rating (“G,” “PG,” “PG-13,” “R,” or “NC-17”) is converted to a predetermined rating (“TV-Y,” “TV-Y7,” “TV-G,” “TV-PG,” “TV-14,” or “TV-MA”) in the FCC rating system. In such embodiments, memory 630 includes a simple lookup table that rating-insertion module 665 consults to map the MPAA ratings to their corresponding FCC ratings.

In some embodiments, CPE 600 includes multiple media processing units 620, each including a separate decoder configured to decode a particular portion of the digital content 635 to produce a corresponding decoded-content stream similar to decoded content 640. In one embodiment, CPE 600 includes three media processing units 620. Such an embodiment is similar to that shown in FIG. 6A, except that there is a separate media processing unit 620 including a decoder (see, e.g., decoder 210 in FIG. 3) for each stream, and modulator 645 is configured to accept multiple decoded-content inputs such as decoded content 640. In such an embodiment, rating-insertion module 665 is also configured to embed rating indicators in multiple decoded-content streams.

Modulator 645, in such an embodiment, is configured to modulate the decoded content (640) produced by a given media processing unit 620 onto its own unique carrier frequency. Thus, a viewer can tune an analog television on the premises to any of the predetermined carrier frequencies to receive a particular stream. Once tuned to a particular carrier frequency carrying a particular stream, the analog television can selectively block programs based on the embedded rating indicators within that stream, as described above.

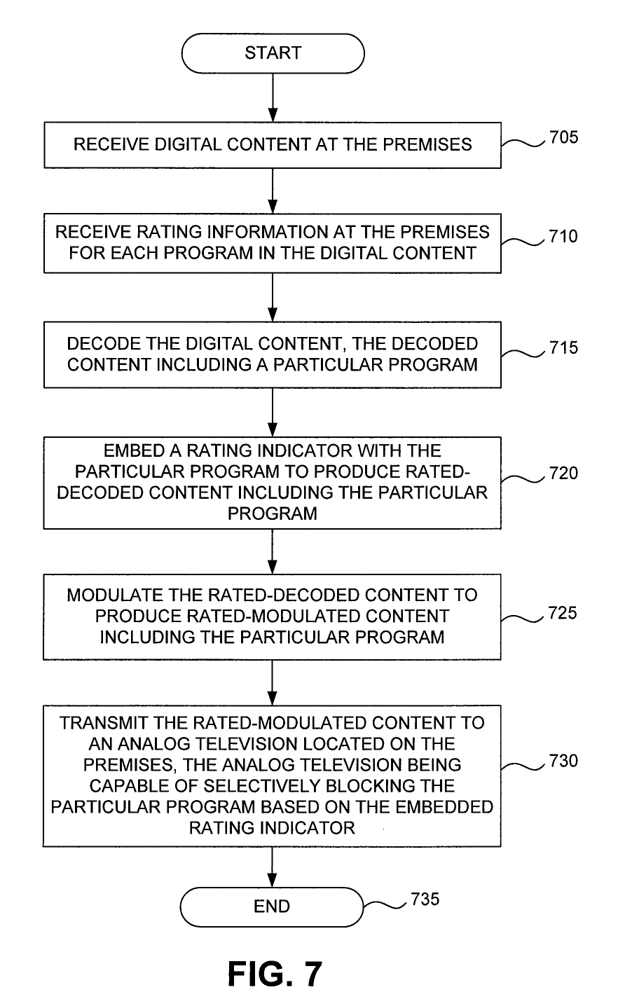

FIG. 7 is a flowchart of a method for controlling access to media content within a premises in accordance with an illustrative embodiment of the present invention. At 705, digital-media interface 605 receives digital content 635 at the premises, the digital content 635 including separate programs. The separate programs can be temporally separate, from separate sources, or both. At 710, rating-insertion module 665 receives, at the premises, rating information for each of the separate programs in the digital content 635. This rating information enables rating-insertion module 665 to associate one of a plurality of rating indicators with each of the separate programs for which rating information is available. Each rating indicator identifies a particular class of content (e.g., “TV-PG”).

At 715, media processing unit 620 decodes digital content 635 to produce decoded content 640, the decoded content including a particular program among the separate programs. At 720, rating-insertion module 665 embeds with the particular program in decoded content 640 a rating indicator associated with the particular program to produce rated-decoded content that includes the particular program. At 725, modulator 745 modulates the rated-decoded content to produce, at RF output 650, rated-modulated content that includes the particular program with its embedded rating indicator. At 730, CPE 600 transmits, from RF Output 650, the rated-modulated content to an analog television on the premises that is capable of selectively blocking the particular program based on the embedded rating indicator. At 735, the process terminates.

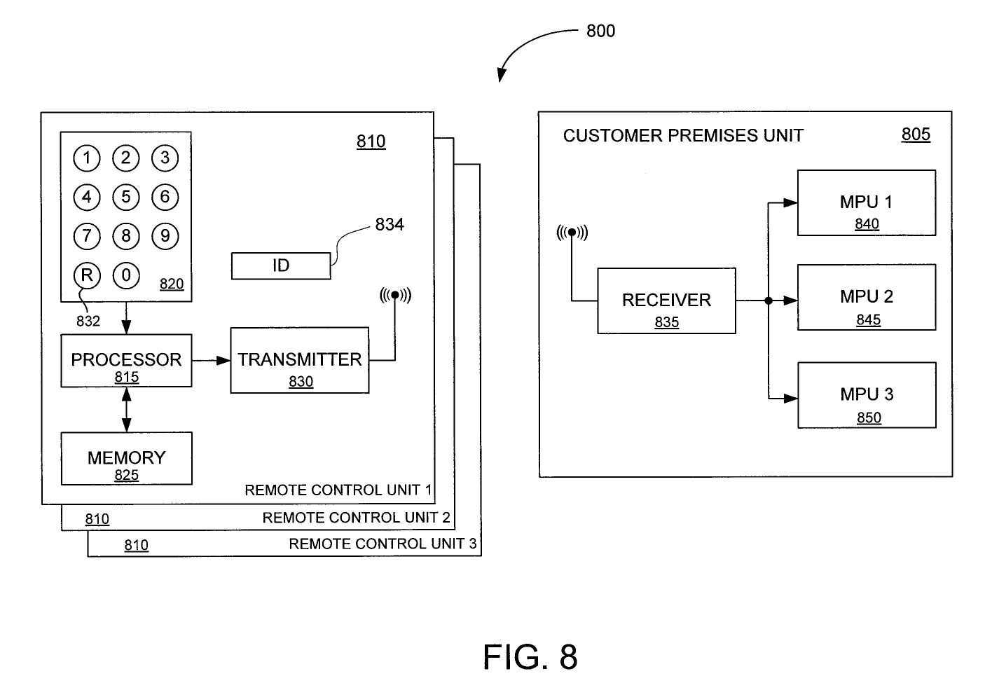

Referring next to FIG. 8, it is a functional block diagram of an on-premises digital media distribution system (“system”) 800 in accordance with an illustrative embodiment of the invention. As described above in connection with other embodiments, system 800 is configured to decode and modulate received digital media content for distribution in analog format within a premises. System 800 includes a customer premises unit (CPE) 805 and one or more remote control units 810 (three are shown in FIG. 8 merely for illustrative purposes). In this embodiment, remote control units 810 are of the wireless variety. For example, in one particular embodiment, remote control units 810 transmit at radio frequency (RF). Each remote control unit 810 includes a processor 815 that receives user input via keypad 820 and that also communicates with memory 825 and RF transmitter 830.

In FIG. 8, keypad 820 has been simplified for the purposes of illustration. That is, keypad 820 may include a variety of additional buttons or other control elements for controlling an interactive media session such as “channel up,” “channel down,” “mute,” etc., that are not shown in FIG. 8. In FIG. 8, keypad 820 includes, in addition to the numerical keys “0” through “9,” registration key 832 (labeled “R” in FIG. 8). Some uses for registration key 832 will be explained below.

Memory 825 contains program instructions configured to cause processor 815 to carry out the various functions of a remote control unit 810. Memory 825 may, depending on the particular embodiment, include random-access memory (RAM), read-only memory (ROM), flash memory, other types of storage, or a combination thereof. In general, the functionality of a remote control unit 810 may be implemented in software, firmware, hardware, or a combination thereof.

Each remote control unit 810 also has an associated unique identifier 834 (labeled “ID” in FIG. 8) that is assigned to that particular remote control unit 810. ID 834 is unique at least to the extent that no other remote control unit 810 within the same premises (or within a given system 800) has the same ID 834, and no system 800 on a different premises in the vicinity of a particular system 800 includes a remote control unit 810 with the same associated ID 834. The reason for assigning a unique ID 834 to each remote control unit 810 will become apparent below. Depending on the embodiment, ID 834 may reside in memory 825 or in some other nonvolatile storage area within a remote control unit 810.

CPE 805 shown in FIG. 8 is somewhat simplified compared with other CPEs shown in prior figures in connection with other embodiments. For clarity, not all components of CPE 805 are shown in FIG. 8. In FIG. 8, CPE 805 includes an RF receiver 835 and a plurality of media processing units (MPUs) 840, 845, and 850 that function as described above in connection with any of the various embodiments of the invention. Three MPUs are shown in FIG. 8 merely for illustrative purposes. In some embodiments, the number of MPUs happens to be three. In other embodiments, there may be fewer or more MPUs than three.

RF receiver 835 is configured to receive wireless signal transmissions from one or more remote control units 810. The messages received from remote control units 810 are fed to the MPUs for execution of commands embedded within the messages. Each received command alters the settings and functions of a particular MPU for which that command is intended. The mapping of remote control units 810 to corresponding MPUs within CPE 805 will be explained in detail below. In general, a user can control the operation of a particular MPU in CPE 805 using a specific remote control unit 810. This allows a user to control, for example, an interactive television session or service that is processed by that particular MPU.

CPE 805 also includes one or more input controls (not shown in FIG. 8) by which a user can control the operation of CPE 805 directly. Using these input controls, a user can specify that CPE 805 is to operate in a particular manner. In “operating mode,” CPE 805 operates normally to receive digital media content and to decode, modulate, and distribute analog content within a premises, as described above. In “registration mode,” a message received from a remote control unit 810 is capable of mapping (binding) that remote control unit 810 to a particular MPU of CPE 805. That is, a registration message received from a remote control unit 810 by CPE 805 while CPE 805 is in this special registration mode binds that remote control unit 810 to a specific MPU within CPE 805, as will be explained more fully below.

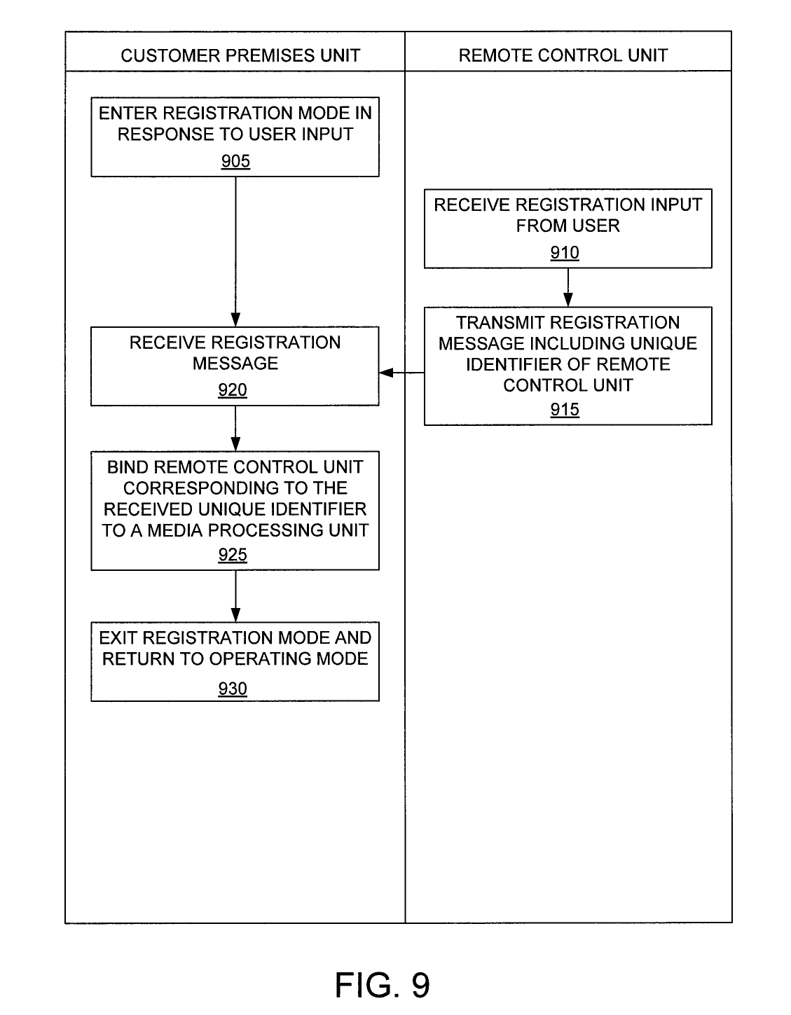

FIG. 9 is a flow diagram of a method for controlling a CPE 805 in accordance with an illustrative embodiment of the invention. At 905, CPE 805 enters registration mode in response to input from a user, as explained above. While CPE 805 is in registration mode, a remote control unit 810 receives a registration input from the user at 910. In one embodiment, the user enters the registration input by pressing registration key 832 on the remote control unit 810. In response to the registration input, remote control unit 810, at 915, transmits a registration message that includes the unique ID 834 associated with that remote control unit 810.

At 920, CPE 805 receives and interprets the registration message. At 925, CPE 805 binds the particular remote control unit 810 from which the registration message was received to a MPU by mapping the received ID 834 assigned to that remote control unit 810 to that MPU and only to that MPU. Once a remote control unit 810 is bound to a MPU in this way, that MPU subsequently responds only to those command messages that include the ID 834 of the remote control unit 810 that has been bound to it. That is, the MPU ignores command messages containing IDs 834 other than that of the remote control unit 810 that has been bound to it. Such a mapping of remote control units 810 to MPUs thus solves the problem described in the Background of the Invention by enabling each MPU to determine from which remote control unit 810 a particular command message originated. In this embodiment, the mapping of a remote control unit 810 to a particular MPU is permanent until overridden by a subsequent registration message.

In some embodiments, multiple remote control units 810 may be bound to a single MPU. In such a configuration, the MPU responds to commands from any of the remote control units 810 that have been bound to it. The reverse—a single remote control unit 810 being assigned to multiple MPUs—is generally not advisable because it would be ambiguous which interactive media session is to be controlled via that remote control unit 810. One advantage of having multiple remote control units 810 bound to a single MPU is that a user may have remote control units 810 in different rooms, each configured to control the same interactive media session or service. This frees the user from having to carry a remote control unit 810 from room to room. Multiple remote control units 810 can be bound to a single MPU by simply repeating a process such as that shown in FIG. 9 for each remote control unit 810.

At 930, CPE 805 exits registration mode and returns to operating mode. In some embodiments, the user manually returns CPE 805 to operating mode from either CPE 805 or from the remote control unit 810. In other embodiments, CPE 805 automatically returns to its normal operating mode once a remote control unit 810 has been bound to an MPU.

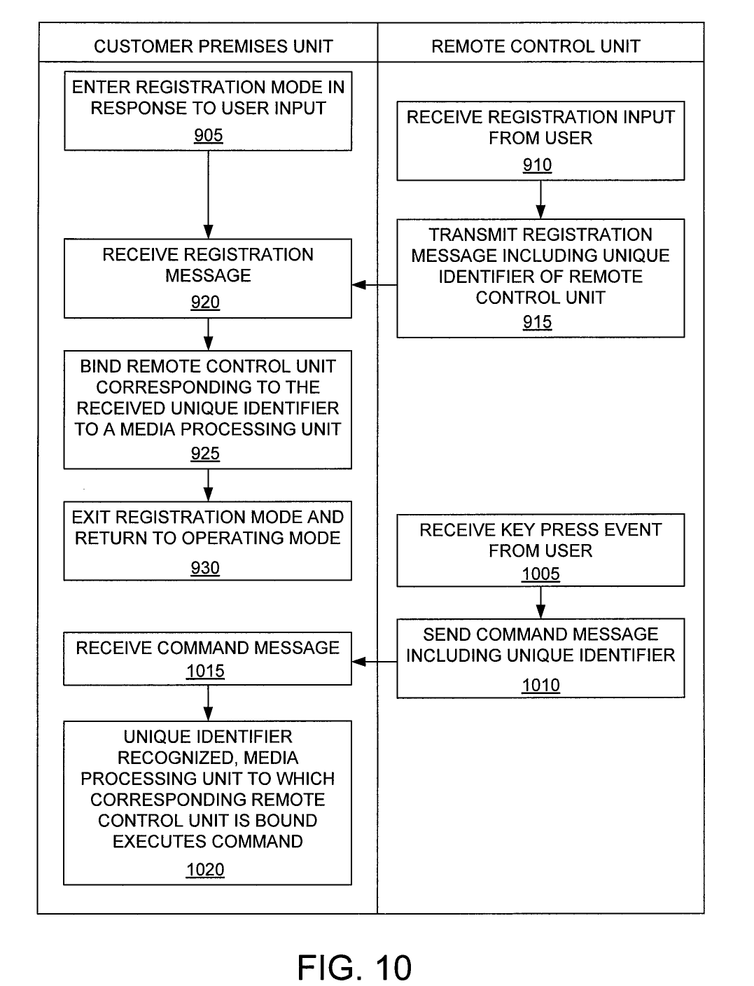

FIG. 10 is a flow diagram of a method for controlling a CPE 805 in accordance with another illustrative embodiment of the invention. In FIG. 10, the process proceeds as in FIG. 9 through Block 930. At 1005, a remote control unit 810 receives a key press event from the user. A key press event may be of various types such as a key press, a key release, or a key hold. A key press event also involves a particular key or other input control on keypad 820 (see FIG. 8), each of which has a unique numeric code associated with it. Thus, a key press event includes an event type and a numeric code corresponding to the actuated key or other input control on keypad 820.

At 1010, remote control unit 810 transmits a command message that includes the unique ID 834 of that remote control unit 810. More about the format of the messages transmitted from the remote control unit 810 to the CPE 805 will be described below. At 1015, CPE 805 receives the command message. At 1020, the MPU to which the transmitting remote control unit 810 is bound recognizes the unique ID 834 associated with that remote control unit 810 and responds by executing the command contained in the received command message.

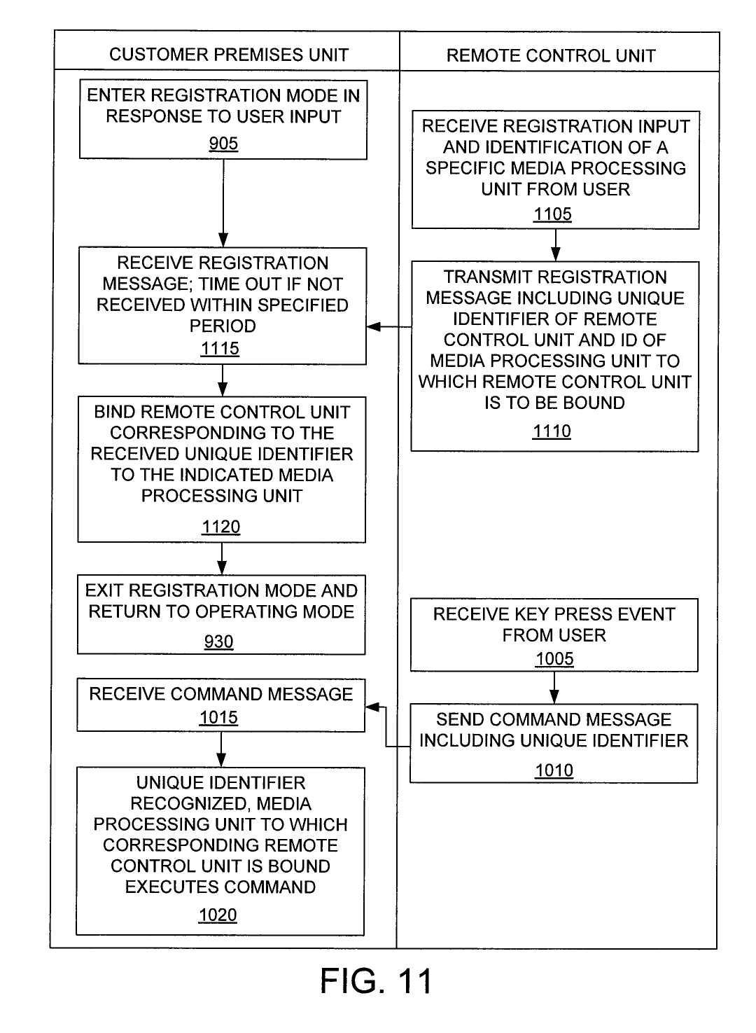

The MPU to which a particular remote control unit 810 is bound may be selected in several different ways, depending on the embodiment. In one embodiment, CPE 805 includes only one MPU, and there is no selection to be made. In other embodiments, CPE 805 includes a plurality of MPUs as in FIG. 8, and the user specifies a specific MPU from among the plurality when registering the remote control unit 810 with the CPE 805, as shown in FIG. 11.

FIG. 11 is a flow diagram of a method for controlling a CPE 805 in accordance with yet another illustrative embodiment of the invention. The process shown in FIG. 11 is similar to that shown in FIG. 10 but differs in some respects. At 1105, remote control unit 810 receives a registration input from the user that includes an identification of a specific MPU to which the remote control unit 810 is to be bound. For example, the MPUs 840, 845, and 850 shown in FIG. 8 might be numbered MPU 1, MPU 2, and MPU 3, as shown in that figure. To bind a remote control unit 810 to MPU 2, the user might press registration key 832 followed by “2” on keypad 820. The resulting registration message that is transmitted at 1110 includes both the unique ID 834 of remote control unit 810 and an indication (e.g., a numerical code such as “2”) that MPU 2 is the MPU to which the remote control unit 810 is to be bound.

At 1115, CPE 805 receives the registration message as at Block 920 in FIG. 9. In this illustrative embodiment, CPE 805 automatically times out the registration mode and returns to operating mode if a registration message is not received within a specified period after registration mode is entered. That period could be, for example, several seconds to a minute or two, depending on the embodiment. Such a parameter is also adjustable in some embodiments.

At 1120, CPE 805 binds the remote control unit 810 from which the registration message was received to the MPU specified in the registration message.

The remainder of the process proceeds as indicated in FIG. 10.

The signaling from remote control units 810 to CPE 805 may be implemented in a variety of different ways. In one embodiment, remote control units 810 employ Amplitude Shift Keying (ASK), also known as On-Off Keying (OOK). During an “on” cycle, the transmission power is high (i.e. the amplitude is high). During an “off” cycle, the transmission power is low (i.e. the amplitude is low). In another embodiment, remote control units 810 employ a different modulation technique such as Frequency Shift Keying (FSK). In general, any modulation scheme suitable for the transmission of binary data may be used.

In one embodiment, the message protocol uses a well known technique called Manchester encoding, which formats binary data in a manner suited for RF transmitters and receivers. Data is transmitted in the form of symbols, where each symbol represents one bit of binary data. One symbol is transmitted per two clock cycles. A symbol consists of either one “on” clock cycle immediately followed by one “off” clock cycle, or one “off” clock cycle immediately followed by one “on” clock cycle.

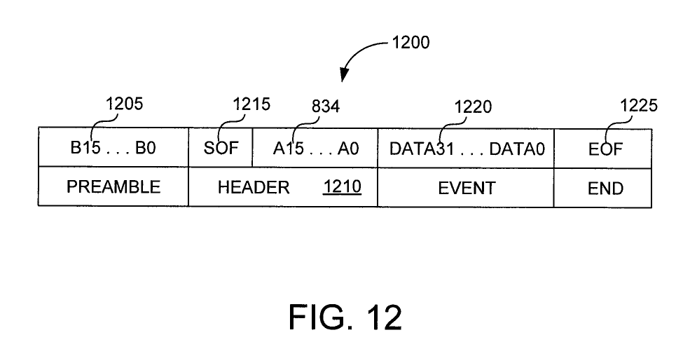

The RF remote-control protocol structure can also take on a variety of forms, depending on the particular embodiment. FIG. 12 is a diagram of a wireless remote control message format in accordance with an illustrative embodiment of the invention. The message format 1200 shown in FIG. 12 includes five parts: (1) a preamble 1205, (2) a header 1210 that includes a start-of-frame (SOF) value 1215 and a unique ID 834 associated with the transmitting remote control unit 810 (shown as address bits A0 to A15 in FIG. 12), (3) event data 1225 (shown as data bits Data0 to Data31 in FIG. 12), and end-of-frame (EOF) value 1230.

In this illustrative embodiment, preamble 1205 is a sequence of evenly spaced on/off transmissions. This sequence allows receiver 835 of CPE 805 to calibrate its receiving sensitivity prior to receiving data. Preamble 1205 is not interpreted as binary data; rather, it is merely a pattern that is useful for calibrating receiver 835.

SOF value 1215 consists of 6 consecutive “on” clock cycles, followed by four consecutive “off” cycles. SOF value 1215 is not Manchester encoded. Instead, it is used to delimit the start of a transmission frame. This unique pattern will not occur during a normal transmission, so it serves to mark unambiguously the beginning of the frame.

As explained above, ID 834 is a unique identifier assigned to each remote control unit 810 (e.g., during manufacturing). Each remote control unit 810 includes its Address (ID 834) in each frame it transmits, enabling CPE 805 to determine the source of each received frame. ID 834 may be a numerical value, a sequence of alphanumeric characters, or any other computer-representable pattern that uniquely identifies the remote control unit 810 to which it is assigned.

As explained above, event data 1225 includes an event type and a code of some sort corresponding to an actuated key or other input control of remote control unit 810.

In this illustrative embodiment, EOF value 1230 consists of two consecutive “on” cycles followed by two consecutive “off” cycles.

Those skilled in the art will recognize that the message format 1200 discussed above can be adapted to accommodate the transmission of both registration messages and command messages. A registration message might include, for example, a particular code (e.g., among the event data 1225) indicating that the remote control unit 810 whose associated ID 834 is embedded within the registration message is to be bound to a specific MPU within CPE 805.

In conclusion, the present invention provides, among other things, a method and apparatus for controlling an on-premises digital media distribution system. Those skilled in the art can readily recognize that numerous variations and substitutions may be made in the invention, its use, and its configuration to achieve substantially the same results as achieved by the embodiments described herein. Accordingly, there is no intention to limit the invention to the disclosed exemplary forms. Many variations, modifications, and alternative constructions fall within the scope and spirit of the disclosed invention as expressed in the claims. For example, though the techniques described above in connection with FIGS. 8-12 have been described in terms of controlling an on-premises digital media distribution system, the principles involved can be applied to controlling other types of electronic devices and systems in which a plurality of different resources may be controlled by multiple users from multiple remote control units.

What is claimed is:

1. A method for controlling a device, the method comprising:
placing the device in a registration mode in response to an input to the device from a user, the device being configured to decode and modulate received digital media content for distribution in analog format within a premises;
receiving in a wireless remote control unit that is separate from the device a registration input from the user;
transmitting, responsive to the registration input, a registration message from the wireless remote control unit to the device while the device is in the registration mode, the registration message including a unique identifier associated with the wireless remote control unit;
binding the wireless remote control unit to a media processing unit within the device in response to the registration message such that the media processing unit responds to only those command messages subsequently received from the wireless remote control unit that contain the unique identifier associated with the wireless remote control unit; and
terminating the registration mode and resuming an operating mode in the device.

2. The method of claim 1, wherein the digital media content includes television programming.

3. The method of claim 1, further comprising:
receiving a key press event in the wireless remote control unit;
transmitting to the device a command message corresponding to the key press event, the command message including the unique identifier associated with the wireless remote control unit; and
executing, in the media processing unit, a command specified by the command message in response to the command message containing the unique identifier associated with the wireless remote control unit.

4. The method of claim 3, wherein the digital media content includes television programming and the command pertains to a function affecting an interactive television session processed by the media processing unit.

5. The method of claim 1, further comprising:
receiving in the wireless remote control unit from the user, prior to the transmitting, an identification of a particular media processing unit among a plurality of media processing units within the device;
wherein the particular media processing unit is the media processing unit to which the wireless remote control unit is bound in response to the registration message.

6. The method of claim 1, wherein the method is repeated for at least one additional wireless remote control unit such that a plurality of wireless remote control units are bound to the media processing unit, the media processing unit responding to only those command messages that contain a unique identifier associated a wireless remote control unit in the plurality of wireless remote control units.

7. The method of claim 1, wherein the registration mode is automatically terminated and the operating mode is resumed in the device when no registration message is received by the device within a predetermined period following initiation of the registration mode.

8. A system, comprising:
a customer premises unit to decode and modulate received digital media content for distribution in analog format within a premises, the customer premises unit including a media processing unit; and
a wireless remote control unit to control the operation of the customer premises unit;
wherein:
the customer premises unit is configured to enter a registration mode in response to an input to the customer premises unit from a user;
the wireless remote control unit is configured to receive a registration input from the user and, responsive thereto, to transmit a registration message to the customer premises unit while the customer premises unit is in the registration mode, the registration message including a unique identifier associated with the wireless remote control unit;
the customer premises unit is configured to bind, in response to the registration message, the wireless remote control unit to the media processing unit such that the media processing unit responds to only those command messages subsequently received from the wireless remote control unit that contain the unique identifier associated with the wireless remote control unit; and
the customer premises unit is configured to terminate the registration mode and resume an operating mode once the wireless remote control unit has been bound to the media processing unit.

9. The system of claim 8, wherein the digital media content includes television programming.

10. The system of claim 8, wherein:
the wireless remote control unit is configured, after the wireless remote control unit has been bound to the media processing unit, to receive a key press event from the user and to transmit to the customer premises unit a command message corresponding to the key press event, the command message including the unique identifier associated with the wireless remote control unit; and
the media processing unit is configured to execute a command specified by the command message in response to the command message containing the unique identifier associated with the wireless remote control unit.

11. The system of claim 10, wherein the digital media content includes television programming and the command pertains to a function affecting an interactive television session processed by the media processing unit.

12. The system of claim 8, wherein:
the wireless remote control unit is configured to receive from the user, prior to transmission of the registration message, an identification of a particular media processing unit among a plurality of media processing units within the device; and
the particular media processing unit is the media processing unit to which the customer premises unit binds the wireless remote control unit in response to the registration message.

13. The system of claim 8, wherein a plurality of different wireless remote control units are bound to the media processing unit such that the media processing unit responds to only those command messages that contain a unique identifier associated a wireless remote control unit in the plurality of different wireless remote control units.

14. The system of claim 8, wherein the customer premises unit is configured to terminate the registration mode automatically and to resume the operating mode when no registration message is received by the customer premises unit within a predetermined period following initiation of the registration mode.

15. The system of claim 8, wherein the wireless remote control unit transmits messages to the customer premises unit at radio frequency.

16. The system of claim 15, wherein the wireless remote control unit is configured to transmit digital signals to the customer premises unit using Manchester-encoded Amplitude Shift Keying.

17. The system of claim 15, wherein the wireless remote control unit is configured to transmit digital signals to the customer premises unit using Manchester-encoded Frequency Shift Keying.

18. A method for controlling a device, the method comprising:
placing the device in a registration mode in response to an input to the device from a user, the device being configured to decode and modulate received digital media content for distribution in analog format within a premises;
receiving in a wireless remote control unit that is separate from the device a registration input from the user;
transmitting, responsive to the registration input, a registration message from the wireless remote control unit to the device while the device is in the registration mode, the registration message including a unique identifier associated with the wireless remote control unit;
binding, in response to the registration message, the wireless remote control unit to a media processing unit within the device such that the media processing unit responds to only those command messages subsequently received from the wireless remote control unit that contain the unique identifier associated with the wireless remote control unit;
terminating the registration mode and resuming an operating mode in the device;
receiving a key press event in the wireless remote control unit;
transmitting to the device a command message corresponding to the key press event, the command message including the unique identifier associated with the wireless remote control unit; and
executing, in the media processing unit, a command specified by the command message in response to the command message containing the unique identifier associated with the wireless remote control unit.

19. A system, comprising:
a customer premises unit to decode and modulate received digital media content for distribution in analog format within a premises, the customer premises unit including a media processing unit; and
a wireless remote control unit to control the operation of the customer premises unit;
wherein:
the customer premises unit is configured to enter a registration mode in response to an input to the customer premises unit from a user;
the wireless remote control unit is configured to receive a registration input from the user and, responsive thereto, to transmit a registration message to the customer premises unit while the customer premises unit is in the registration mode, the registration message including a unique identifier associated with the wireless remote control unit;
the customer premises unit is configured to bind, in response to the registration message, the wireless remote control unit to the media processing unit such that the media processing unit responds to only those command messages subsequently received from the wireless remote control unit that contain the unique identifier associated with the wireless remote control unit;
the customer premises unit is configured to terminate the registration mode and resume an operating mode once the wireless remote control unit has been bound to the media processing unit;
the wireless remote control unit is configured, after the wireless remote control unit has been bound to the media processing unit, to receive a key press event from the user and to transmit to the customer premises unit a command message corresponding to the key press event, the command message including the unique identifier associated with the wireless remote control unit; and
the media processing unit is configured to execute a command specified by the command message in response to the command message containing the unique identifier associated with the wireless remote control unit.
